(19) United States
(12) Patent Application Publication
(10) Pub. No.: US 2019/0378054 A1
(43) Pub. Date: Dec. 12, 2019

(54) Planning and Simulating Tourist Trips using Navigation and Location Tracking Data

(71) Applicant: International Business Machines Corporation, Armonk, NY (US)

(72) Inventors: Florian Pinel, New York, NY (US); Jacquelyn Martino, Cold Spring, NY (US); Benjamin L. Johnson, Baltimore City, MD (US)

(21) Appl. No.: 16/001,071

(22) Filed: Jun. 6, 2018

(51) Int. Cl. G06Q 10/02; G06F 17/30

(52) U.S. Cl. CPC G06Q 10/02; G06F 3/0482; G06F 17/3043

(57) ABSTRACT

An approach is provided to generate a trip itinerary. The approach receives a set of points of interest from a user with the user being one of a number of user that uses the system. The approach then retrieves user-defined factors from a user travel-based corpus that is accessible from a question-answering (QA) system with the user travel-based corpus corresponding to the requesting user. The QA system is utilized to analyze the user-defined factors in relation to each of the points of interest. In addition, constraints that pertain to each of the points of interest are identified by the QA system utilizing travel oriented data that has been ingested into the QA system. The approach then generates an itinerary based upon the analysis and the identified constraints.

### BACKGROUND

Modern travel related web sites assist users in reserving travel and accommodations and planning activities. Many of these web sites have ratings and recommendations provided by other users. In addition, depending on the lead time and destination, weather sites provide users with anticipated forecasts. While the accuracy of such forecasts diminishes when more time is between the user's planning session and the actual destination dates, such information can provide the user with an idea of what the weather conditions are likely to be expected at the destination.

### BRIEF SUMMARY

According to one embodiment of the present invention, an approach is provided in which generates a trip itinerary. The approach receives a set of points of interest from a user with the user being one of a number of users that use the system. The approach then retrieves user-defined factors from a user travel based corpus that is accessible from a question-answering (QA) system with the user travel based corpus corresponding to the requesting user. The QA system is utilized to analyze the user-defined factors in relation to each of the points of interest. In addition, constraints that pertain to each of the points of interest are identified by the QA system utilizing travel oriented data that has been ingested into the QA system. The approach then generates an itinerary based upon the analysis and the identified constraints.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present invention may be better understood, and its numerous objects, features, and advantages made apparent to those skilled in the art by referencing the accompanying drawings, wherein:

FIG. 1 depicts a schematic diagram of one illustrative embodiment of a question/answer creation (QA) system in a computer network;

FIG. 2 illustrates an information handling system, more particularly, a processor and common components, which is a simplified example of a computer system capable of performing the computing operations described herein;

FIG. 3 is a system diagram depicting the components utilized in planning and simulating tourist trips using navigation and location tracking data;

FIG. 4 is a flowchart showing steps performed during user trip configuration;

FIG. 5 is a flowchart showing steps performed during user trip planning;

FIG. 6 is a flowchart showing steps performed during trip simulation; and

FIG. 7 is a flowchart showing steps performed during trip tracking and dynamic modification of trip details based on near-real-time trip event occurrences.

### DETAILED DESCRIPTION

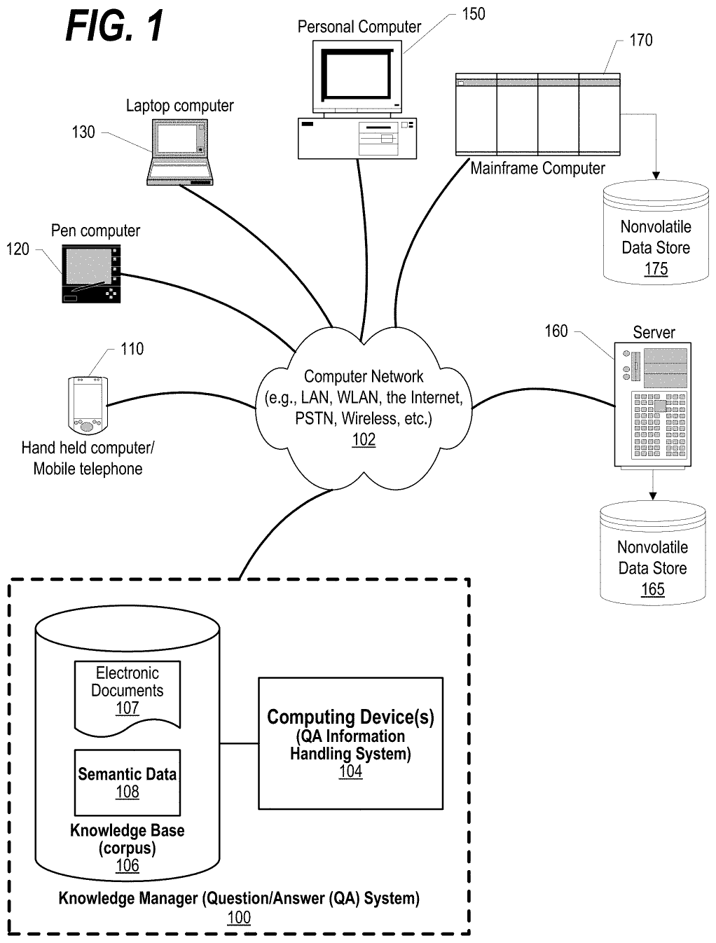

FIGS. 1-7 depict an approach that performs planning and simulating tourist trips using navigation and location tracking data. The approach automatically arranges a given set of points of interest (e.g., hotels, restaurants, tourist attractions, activities, etc.) into an itinerary that is optimized against one or more user-defined factors such as time, walking distance, cost, crowdedness, and the like. Users select the places and activities they wish to visit and attend during their travels and also provide dates and trip duration information. The approach uses information from travel and navigation applications, as well as information learned from the user, to generate a timeline where all of the points of interest appear in an optimal sequence along with instructions to travel from one point of interest to the next. The approach calculates visit duration estimates for each point of interest and optimizes the point of interest mix according to the user's preferences. For example, the user may indicate that a sequence of museums is not preferred and that the user prefers a mix of indoor and outdoor activities. The approach, using the user's information learned over time, can suggest additional points of interest, such as restaurants and hotels, that fit within the user's itinerary timeframe as well as mesh with the user's travel personal preferences. During the user's actual trip, the system monitors the user's travels, reminds the user of upcoming activities, and updates the itinerary as needed in real time based on the user's deviations from the itinerary due to either personal preferences or due to unexpected delays, weather changes or outages experienced during the user's travels.

The approach further simulates the user's travels using a multimedia experience that provides the user with images, videos, audio clips, maps, and the like that highlight the user's chosen points of interest and travel expectations between such points of interest. The simulation can be used as a tool to allow the user to adjust the itinerary based upon time allotted to particular points of interest or other user preferences. The system uses a question-answering system to learn the individual user's travel preferences and experiences so that, over time, the system can better anticipate the user's preferences on other trips and better suggest points of interest and time allotments to schedule for such points of interest to better match the user's preferences. The approach utilizes a Question-Answering (QA) system, or “knowledge manager,” to analyze data pertaining to the points of interest and the user's travel preferences. As used herein, a Question-Answering (QA) system is the same as a “knowledge manager” and these terms can be used interchangeably to refer to a computer system that applies advanced natural language processing, information retrieval, knowledge representation, automated reasoning, and machine learning technologies to the answer questions and provide predictions based on previously learned information. In the case of the instant system, the system that plans, simulates, and tracks a user's trips using navigation and location tracking data learns from a user's past actions, preferences, and behaviors in order to better predict and suggest points of interest and other trip activities that may be of interest or preferred by a particular user.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

FIG. 1 depicts a schematic diagram of one illustrative embodiment of a question/answer (QA) system 100 in a computer network 102. QA system 100 may include knowledge manager 104, which comprises one or more processors and one or more memories, and potentially any other computing device elements generally known in the art including buses, storage devices, communication interfaces, and the like. Computer network 102 may include other computing devices in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments may include QA system 100 interacting with components, systems, sub-systems, and/or devices other than those depicted herein.

QA system 100 may receive inputs from various sources. For example, QA system 100 may receive input from the network 102, a corpus of electronic documents 107 or other data, semantic data 108, and other possible sources of input. In one embodiment, some or all of the inputs to QA system 100 route through the network 102 and stored in knowledge base 106. The various computing devices on the network 102 may include access points for content creators and content users. Some of the computing devices may include devices for a database storing the corpus of data. The network 102 may include local network connections and remote connections in various embodiments, such that QA system 100 may operate in environments of any size, including local and global, e.g., the Internet. Additionally, QA system 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, a content creator creates content in a document 107 for use as part of a corpus of data with QA system 100. The document 107 may include any file, text, article, or source of data for use in QA system 100. Content users may access QA system 100 via a network connection or an Internet connection to the network 102, and may input questions to QA system 100, which QA system 100 answers according to the content in the corpus of data. As further described below, when a process evaluates a given section of a document for semantic content, the process can use a variety of conventions to query it from knowledge manager 104. One convention is to send a well-formed question.

Semantic data 108 is content based on the relation between signifiers, such as words, phrases, signs, and symbols, and what they stand for, their denotation, or connotation. In other words, semantic data 108 is content that interprets an expression, such as by using Natural Language Processing (NLP). In one embodiment, the process sends well-formed questions (e.g., natural language questions, etc.) to QA system 100 and QA system 100 may interpret the question and provide a response that includes one or more answers to the question. In some embodiments, QA system 100 may provide a response to users in a ranked list of answers.

An example of QA system 100 may be the IBM Watson™ QA system available from International Business Machines Corporation of Armonk, N.Y., which is augmented with the mechanisms of the illustrative embodiments described hereafter. The QA knowledge manager system may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

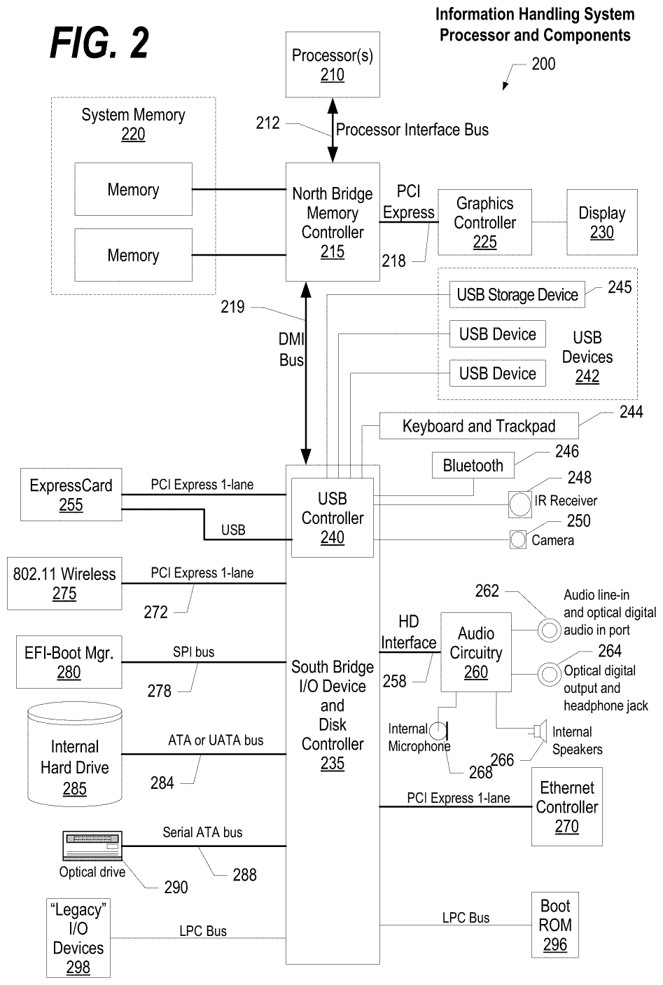

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE .802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

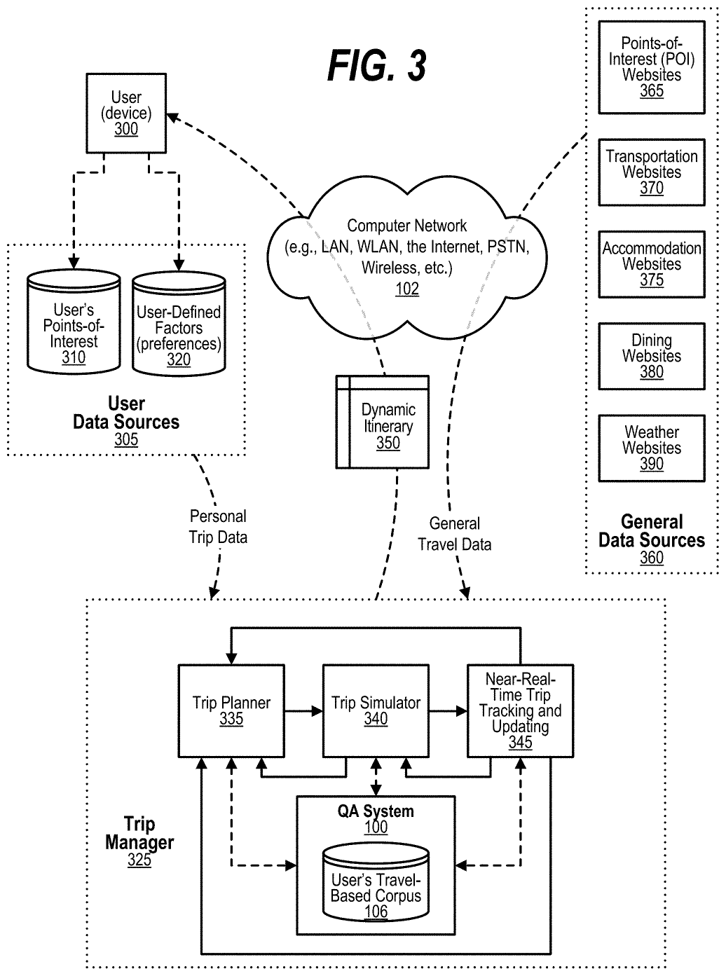

FIG. 3 is a system diagram depicting the components utilized in planning and simulating tourist trips using navigation and location tracking data. Various components depicted can communicate using computer network 102. User 300 utilizes a device, such as one of the types of information handling systems depicted in FIG. 1, to access and use trip manager system 325. User 300 develops, or otherwise provides, user data sources 305 with data store 310 being the user's points of interest, such as those points of interest on a vacation being planned by the user, as well as user-defined factors that are stored in data store 320, such as the user's individual preferences, that are used when planning a trip and generating the user's itinerary (dynamic itinerary 350) by trip manager 325. The user's points of interest included in data store 310 and the user-defined factors stored in data store 320 are both ingested into QA system 100 and included in the user's travel-based corpus 106. In one embodiment, each user that utilizes trip manager 325 has a separate travel-based corpus that includes data that has been ingested by the QA system. In this manner, the QA system, utilizing the separate corpora corresponding to each of the users, learns over time what preferences and actions the user has taken and provided on previous trips so that the system can better anticipate the user's travel preferences and can better generate an itinerary that is most useful to the specific user.

QA system 100 that is utilized by trip manager 325 also ingests general data sources 360 that are ingested into a general travel-based corpus that is utilized by the QA system when analyzing the user-defined factors in relation to the user's desired points of interest for a trip that is being planned. General data sources that are ingested into the QA system include point of interest websites 365, transportation websites 370, accommodation websites 375, dining websites 380, and weather websites 390. The QA system routinely ingests updated data sources so that the data utilized to generate the user's itinerary are kept up to date. This updated information can be used to inform the user of unanticipated developments that might affect the user's travel plans. These developments might include weather forecast changes made to a weather website and transportation changes or cancellations made to a transportation website.

Trip manager 325 includes three subsystems that are used at different stages of the trip management process. First, trip planner process 335 utilizes QA system 100 to plan the user's trip given the user's points of interest and user-defined factors, such as preferences, to generate an initial itinerary 350. Second, trip simulator process 340 also utilizes QA system 100 to simulate the trip by presenting multimedia content to the user. For example, if one of the points of interest is to visit Central Park in New York City, the simulation might present a multimedia show that depicts sights and sounds that the user is likely to encounter in Central Park. Additionally, using other data sources such as those from weather websites 390 ingested into corpus 106 and accessible to QA system 100, the multimedia presentation can be altered based upon the anticipated weather (e.g., depicting Central Park on sunny day, on a rainy day, on a winter day with snow and ice, etc.). The user can request modifications to the itinerary based on the multimedia presented to the user during the simulation.

Third, and finally, during the actual trip, near-real-time trip tracking and updating process 345 is performed during execution of the points of interest to keep track of the user's travels and activities and utilize updated general data sources 360 to inform the user of any unanticipated developments. For example, if a train that was intended to be used by the user on the trip is delayed or canceled, the user is informed of the development and provided with alternative transportation alternatives. In addition, if the transportation alternatives change the amount of time that the user will have at a point of interest, the system will inform the user of the development and the user utilizes trip manager to modify the itinerary on the fly by re-performing the trip planning and trip simulation processes on the remaining points of interest that have not yet been performed on the trip. In this manner, the trip management process is an iterative process that repeatedly utilizes QA system 100 to refine the trip based on developments.

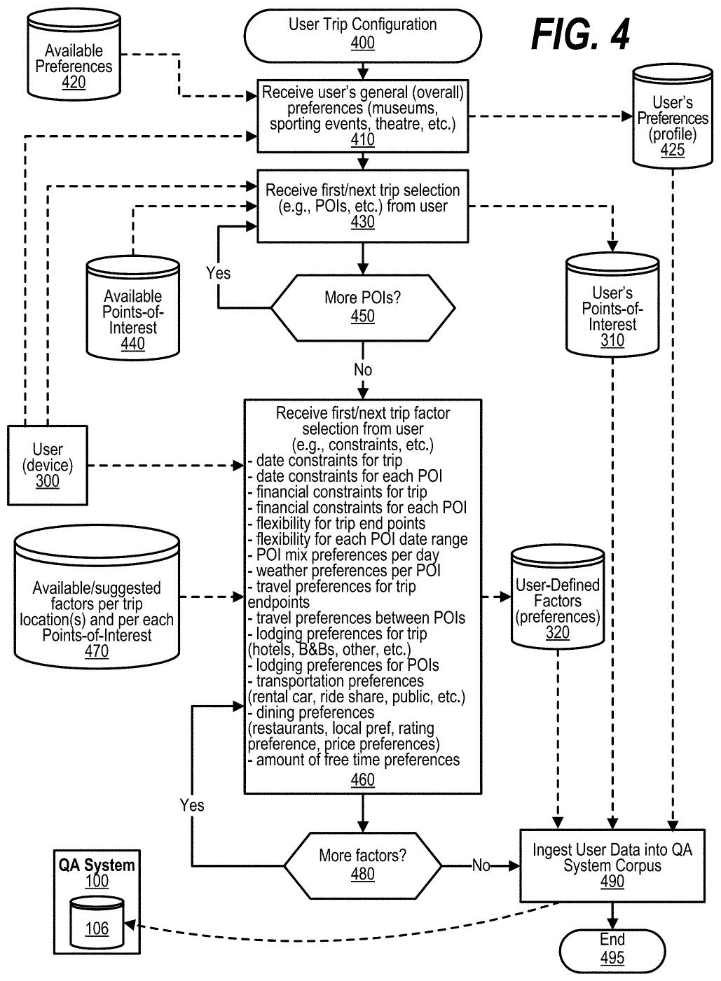

FIG. 4 is a flowchart showing steps performed during user trip configuration. FIG. 4 processing commences at 400 and shows the steps taken by a process that performs a user trip configuration process. At step 410, the process receives the user's general (overall) preferences (museums, sporting events, theatre, etc.). Available preferences are selected from data store 420 and, those selected by the user, are stored as the user's preferences profile in data store 425. At step 430, the process receives the first trip selection (e.g., POIs, etc.) from the user that is utilizing a device, such as a mobile device, desktop computer system, or the like. The list of available points of interest are retrieved from data store 440 and, those selected by the user, are stored in data store 310. The process determines as to whether the user has more POIs that they wish to select for a given trip (decision 450). If there are more POIs selected, then decision 450 branches to the ‘yes’ branch which loops back to step 430 to receive and store the user's next POI selection. This looping continues until the user stops selecting additional POIs, at which point decision 450 branches to the ‘no’ branch exiting the loop.

At step 460, the process receives the user-defined factors from the user (e.g., constraints, etc.). User-defined factors are those factors and constraints pertaining to the overall trip and to particular segments or POIs scheduled for the trip. User-defined factors can include date constraints for the trip, date constraints for each of the segments or POIs, financial constraints for the trip, financial constraints for each of the segments or POIs, the user's flexibility for trip end (date) points as well as the user's flexibility for each segment and/or POI, the user's desired POI mix preferences per day, the user's weather preferences per each POI, the user's travel preferences for trip endpoints as well as the user's travel preferences between segments or POIs of the trip. User-defined factors further include the user's lodging preferences for the trip (hotels, B&Bs, other, etc.) as well as the user's lodging preferences for particular segments or POIs of the trip. User defined factors further include the user's transportation preferences (rental car, ride share, public, etc.) for the trip and particular preferences, the user's dining preferences (e.g., restaurants, local preferences, rating preferences, price preferences, etc.), as well as the user's preferred amount of free time during the trip. The user-defined factors selected by the user are stored in data store 320. In one embodiment, the range of available user-defined factors selectable by the user are retrieved from data store 470.

The process determines as to whether more user-defined factors selected by the user (decision 480). If there are more user-defined factors, then decision 480 branches to the ‘yes’ branch which loops back to step 460 to receive and store the user's next user-defined factor selection. This looping continues until the user stops selecting user-defined factors, at which point decision 480 branches to the ‘no’ branch exiting the loop. At step 490, the process ingests the user data into corpus 106 of QA System 100.

In one embodiment, a corpus is created for each user of the system so that each user's preferences, actions, behaviors, decisions, and the like are learned by QA system 100 rather than having data pertaining to all of the users included in the same corpus. This allows QA system 100 to better anticipate and predict each user's trip activities while planning, simulating and during execution of a trip. The user data that is ingested into QA system 100 includes the user's preference data that were stored in data store 425, the user's points of interest selections that were stored in data store 310, and the user's user-defined factors that were stored in data store 320. FIG. 4 processing of the user configuration process thereafter ends at 495.

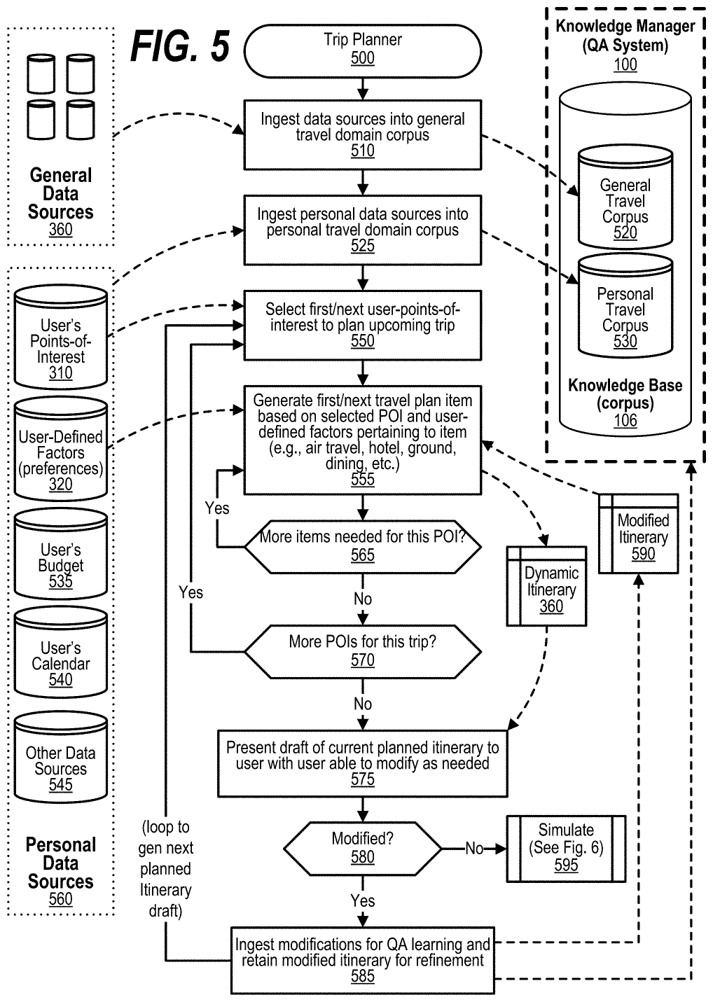

FIG. 5 is a flowchart showing steps performed during user trip planning. FIG. 5 processing commences at 500 and shows the steps taken by a process that performs a trip planning function. At step 510, the process ingests general data sources gathered from the Internet and stores such general travel data into general travel domain corpus 520. QA system 100 includes knowledge base 106 that include multiple corpora—a general travel corpus of ingested general travel data available from the Internet, and multiple personal travel corpora 530 gathered and ingested from the individual users (travelers) that use the system.

At step 525, the process ingests the personal data sources into personal travel domain corpus 530. As previously described, in one embodiment, each user has a separate corpus related to each user's personal travel activities, preferences, and the like. Personal data sources 560 are gathered from the user's points of interest retrieved from data store 310, the user's user-defined factors (preferences) retrieved from data store 320, the user's budget data retrieved from data store 535, the user's calendar data retrieved from data store 540, as well as other user-oriented data stores 545.

At step 550, the process selects the first user selected point of interest (POI) from data store 310 to plan the user's upcoming trip. At step 555, the process generates the first travel plan item based on the selected POI and the user's user-defined factors pertaining to the selected item (e.g., air travel, hotel, ground, dining, etc.) with such factors being retrieved from data store 320. The travel plan items are stored in the user's dynamic itinerary which is stored in memory area 360. The process determines as to whether there are more items needed to be process for the selected POI (decision 565). If there are more items needed to be process for the selected POI, then decision 565 branches to the ‘yes’ branch which loops back to step 555 to generate the next travel plan item. This looping continues until there are no more items needed to process for the selected POI, at which point decision 565 branches to the ‘no’ branch exiting the loop. The process determines as to whether there are additional POIs to process for this trip (decision 570). If there are additional POIs to process for this trip, then decision 570 branches to the ‘yes’ branch which loops back to step 550 to select and process the next POI from data store 310. This looping continues until there no more POIs to process for this trip, at which point decision 570 branches to the ‘no’ branch exiting the loop.

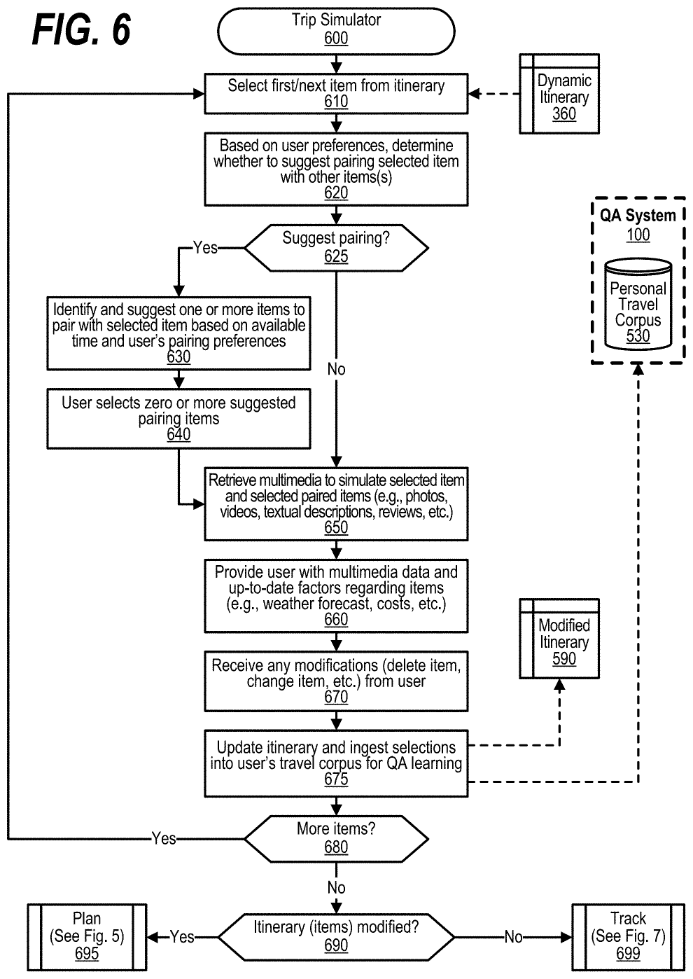

At step 575, the process presents draft of the current planned itinerary from memory area 360 to the user with user being able to indicate desired modifications to the itinerary. The process determines as to whether the user desired modifications to the itinerary (decision 580). If the user desired modifications to the itinerary, then decision 580 branches to the ‘yes’ branch to perform step 585 that ingests modifications made by the user to QA system 100 system so that QA system 100 can learn from the user's modifications and processing loops back to re-generate the user's updated dynamic itinerary based on the modifications. This looping continues until the user no longer desires further modifications to the itinerary, at which point decision 580 branches to the ‘no’ branch to perform predefined process 595. At predefined process 595, the process performs a simulation routine that simulates the POIs found in the user's itinerary by providing a multimedia presentation to the user (see FIG. 6 and corresponding text for processing details).

FIG. 6 is a flowchart showing steps performed during trip simulation. FIG. 6 processing commences at 600 and shows the steps taken by a process that performs a trip simulation routine. At step 610, the process selects the first item from itinerary that has been stored in memory area 360. At step 620, the process determines, based on the user preferences and user defined factors, whether to suggest pairing the selected item with one or more other items. If pairing is suggested, then decision 625 branches to the ‘yes’ branch to perform steps 630 and 640. On the other hand, if pairing is not suggested, then decision 625 branches to the ‘no’ branch bypassing steps 630 and 640.

At step 630, the process identifies and suggests one or more items to pair with the selected item with the suggestions based on the amount of available time and the user's pairing preferences. At step 640, the process receives the user's selection of zero or more suggested pairing items. At step 650, the process retrieves multimedia to simulate the selected item and any selected paired items (e.g., using photos, videos, textual descriptions, reviews, etc. of the various items).

At step 660, the process provides the user with the multimedia data (e.g., in a multimedia presentation, etc.) and also provides up-to-date factors regarding the items (e.g., updated weather forecast, updated costs, etc.). At step 670, the process receives any modifications (e.g., delete item, change item, etc.) from the user, and, at step 675, the process updates the user's itinerary and ingests the user's selections into the user's travel corpus for further QA learning regarding the user's actions and behaviors. The process determines as to whether there are more items to simulate (decision 680). If there are more items to simulate, then decision 680 branches to the ‘yes’ branch which loops back to step 610 to select and simulate the next item from the itinerary. This looping continues until there are no more items to simulate, at which point decision 680 branches to the ‘no’ branch exiting the loop.

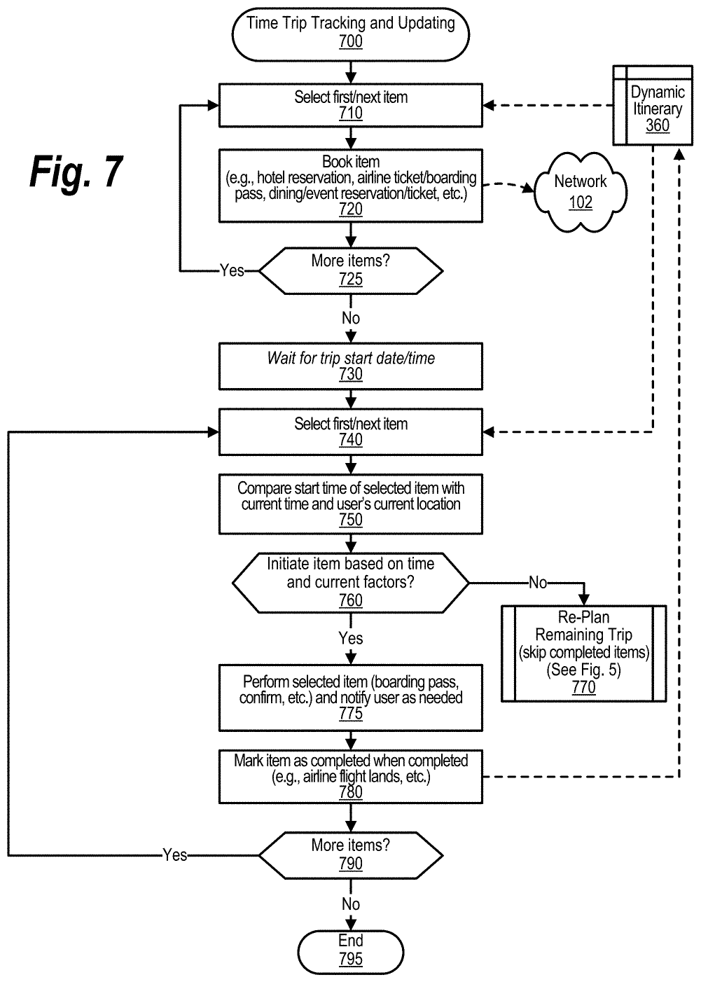

The process determines as to whether the user's itinerary (e.g., items, etc.) were modified during the process (decision 690). If the itinerary was modified, then decision 690 branches to the ‘yes’ branch to re-perform the planning routine with processing executing predefined process 695 (see FIG. 5 and corresponding text for processing details). On the other hand, if the itinerary was not modified, then decision 690 branches to the ‘no’ branch whereupon predefined process 699 is performed. At predefined process 699, the process performs the Tracking routine that tracks the user's actual trip and dynamically makes adjustments based on conditions encountered (see FIG. 7 and corresponding text for processing details).

FIG. 7 is a flowchart showing steps performed during trip tracking and dynamic modification of trip details based on near-real-time trip event occurrences. FIG. 7 processing commences at 700 and shows the steps taken by a process that tracks the user's actual trip and updates the user's itinerary as needed. At step 710, the process selects the first item from the user's itinerary that is stored in memory area 360. At step 720, the process books the selected item as needed (e.g., makes the user's hotel reservation, books the user's airline ticket, receives the user's boarding pass, makes the user's dining and/or event reservations, books ticket needed for the item, and the like). The process determines as to whether there are more items on the itinerary to process (decision 725). If there are more items on the itinerary to process, then decision 725 branches to the ‘yes’ branch which loops back to step 710 to select and process the next item. This looping continues until there are no more items to process, at which point decision 725 branches to the ‘no’ branch exiting the loop.

At step 730, the process waits for the actual trip start date and time. When the trip commences, at step 740, the process selects the first item from the user's itinerary that is stored in memory area 360. At step 750, the process compares the start date/time of the selected item with the current date/time and the user's current location. Based on the comparison, the process determines whether to initiate the selected item based on the current date/time and the current factors (decision 760). If the item is being initiated, then decision 760 branches to the ‘yes’ branch to perform steps 775 and 778. On the other hand, if the user is not initiating the selected item based on time and current factors, indicating that the user might wish to make dynamic modifications to the itinerary, then decision 760 branches to the ‘no’ branch whereupon, at predefined process 770, the process re-performs the planning routine of the remaining time on the trip so that the user can alter the trip as desired (see FIG. 5 and corresponding text for processing details).

If the user is not altering the trip then, at step 775, the process performs the selected item (retrieves needed boarding pass, receives needed confirmation, etc.) and notifies the user of the next item on the itinerary. At step 780, the process marks the selected item as completed when the item is actually completed (e.g., airline flight lands, hotel check in occurs, etc.). In addition, the user's corpus maintained by QA system 100 is updated to reflect activities actually performed by the user so that QA system 100 can better learn about the user's actual trip items performed. The process determines as to whether there are more items on the itinerary to process (decision 790). If there are more items on the itinerary to process, then decision 790 branches to the ‘yes’ branch which loops back to step 740 to select and process the next item on the itinerary. This looping continues until there are no more items left on the itinerary to process, at which point decision 790 branches to the ‘no’ branch exiting the loop. FIG. 7 processing thereafter ends at 795.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
receiving a plurality of points of interest from a user, wherein the user is one of a plurality of users;
retrieving one or more user-defined factors from a user travel-based corpus that is accessible from a question-answering (QA) system;
utilizing the QA system to analyze the user-defined factors in relation to each of the points of interest;
identifying one or more constraints pertaining to each of the points of interest utilizing travel-oriented data that has been ingested into the QA system; and
generating an itinerary based upon the analysis and the identified constraints.

2. The method of claim 1 wherein a separate corpus exists corresponding to each of the plurality of users, and wherein each of the separate corpora is accessible by the QA system.

3. The method of claim 1 further comprising:
simulating one or more of the points of interest included in the generated itinerary, wherein the simulating includes:
presenting one or more multimedia content to the user that pertain to the points of interest;
informing the user of an amount of travel time between at least two of the points of interest; and
including an up-to-date weather forecast for at least one of the points of interest;
receiving at least one modification from the user responsive to the simulation; and
modifying the itinerary based on the received modification.

4. The method of claim 1 further comprising:
tracking activity during an execution of the points of interest;
proactively informing the user of modifications to at least one future point of interest included in the itinerary based on an analysis of up-to-date travel data sources ingested into the QA system; and
modifying the generated itinerary based on the up-to-date travel data sources.

5. The method of claim 4 further comprising:
changing at least one transportation event based on the modifications, wherein the up-to-date travel data sources includes one or more transportation data sources and one or more weather related data sources.

6. The method of claim 4 further comprising:
retrieving one or more points of interest from the received points of interest, wherein the one or more points of interests have not yet been performed;
utilizing the QA system to analyze the user-defined factors in relation to each of the one-or-more points of interest;
re-identifying the constraints pertaining to each of the points of interest utilizing the travel-oriented data ingested into the QA system; and
generating an updated itinerary based upon the analysis and the identified constraints.

7. The method of claim 1 further comprising:
ingesting a plurality of user-oriented corpora into the QA system, wherein the plurality of user-oriented corpora includes a separate user-based corpus that exists and corresponds to each of the plurality of users; and
ingesting a plurality of general data sources into a general travel corpus utilized by the QA system, wherein the general data sources include one or more point of interest websites, one or more transportation websites, one or more accommodation websites, one or more dining websites, and one or more weather websites.

8. An information handling system comprising:
one or more processors;
a memory coupled to at least one of the processors;
a set of computer program instructions stored in the memory and executed by at least one of the processors in order to perform actions of:
receiving a plurality of points of interest from a user, wherein the user is one of a plurality of users;
retrieving one or more user-defined factors from a user travel-based corpus that is accessible from a question-answering (QA) system;
utilizing the QA system to analyze the user-defined factors in relation to each of the points of interest;
identifying one or more constraints pertaining to each of the points of interest utilizing travel-oriented data that has been ingested into the QA system; and
generating an itinerary based upon the analysis and the identified constraints.

9. The information handling system of claim 8 wherein a separate corpus exists corresponding to each of the plurality of users, and wherein each of the separate corpora is accessible by the QA system.

10. The information handling system of claim 8 wherein the processors perform further actions comprising:
simulating one or more of the points of interest included in the generated itinerary, wherein the simulating includes:
presenting one or more multimedia content to the user that pertain to the points of interest;
informing the user of an amount of travel time between at least two of the points of interest; and
including an up-to-date weather forecast for at least one of the points of interest;
receiving at least one modification from the user responsive to the simulation; and
modifying the itinerary based on the received modification.

11. The information handling system of claim 8 wherein the processors perform further actions comprising:
tracking activity during an execution of the points of interest;
proactively informing the user of modifications to at least one future point of interest included in the itinerary based on an analysis of up-to-date travel data sources ingested into the QA system; and
modifying the generated itinerary based on the up-to-date travel data sources.

12. The information handling system of claim 11 wherein the processors perform further actions comprising:
changing at least one transportation event based on the modifications, wherein the up-to-date travel data sources includes one or more transportation data sources and one or more weather related data sources.

13. The information handling system of claim 11 wherein the processors perform further actions comprising:
retrieving one or more points of interest from the received points of interest, wherein the one or more points of interests have not yet been performed;
utilizing the QA system to analyze the user-defined factors in relation to each of the one or more points of interest;
re-identifying the constraints pertaining to each of the points of interest utilizing the travel-oriented data ingested into the QA system; and
generating an updated itinerary based upon the analysis and the identified constraints.

14. The information handling system of claim 8 wherein the processors perform further actions comprising:
ingesting a plurality of user-oriented corpora into the QA system, wherein the plurality of user-oriented corpora includes a separate user-based corpus that exists and corresponds to each of the plurality of users; and
ingesting a plurality of general data sources into a general travel corpus utilized by the QA system, wherein the general data sources include one or more point of interest websites, one or more transportation websites, one or more accommodation websites, one or more dining websites, and one or more weather websites.

15. A computer program product stored in a computer readable storage medium, comprising computer program code that, when executed by an information handling system, causes the information handling system to perform actions comprising:
receiving a plurality of points of interest from a user, wherein the user is one of a plurality of users;
retrieving one or more user-defined factors from a user travel-based corpus that is accessible from a question-answering (QA) system;
utilizing the QA system to analyze the user-defined factors in relation to each of the points of interest;
identifying one or more constraints pertaining to each of the points of interest utilizing travel-oriented data that has been ingested into the QA system; and
generating an itinerary based upon the analysis and the identified constraints.

16. The computer program product of claim 15 wherein the actions performed by the information handling system further comprise:
ingesting a plurality of user-oriented corpora into the QA system, wherein the plurality of user-oriented corpora includes a separate user-based corpus that exists and corresponds to each of the plurality of users; and
ingesting a plurality of general data sources into a general travel corpus utilized by the QA system, wherein the general data sources include one or more point of interest websites, one or more transportation websites, one or more accommodation websites, one or more dining websites, and one or more weather websites.

17. The computer program product of claim 15 wherein the actions performed by the information handling system further comprise:
simulating one or more of the points of interest included in the generated itinerary, wherein the simulating includes:
presenting one or more multimedia content to the user that pertain to the points of interest;
informing the user of an amount of travel time between at least two of the points of interest; and
including an up-to-date weather forecast for at least one of the points of interest;
receiving at least one modification from the user responsive to the simulation; and
modifying the itinerary based on the received modification.

18. The computer program product of claim 15 wherein the actions performed by the information handling system further comprise:
tracking activity during an execution of the points of interest;
proactively informing the user of modifications to at least one future point of interest included in the itinerary based on an analysis of up-to-date travel data sources ingested into the QA system; and
modifying the generated itinerary based on the up-to-date travel data sources.

19. The computer program product of claim 18 wherein the actions performed by the information handling system further comprise:
changing at least one transportation event based on the modifications, wherein the up-to-date travel data sources includes one or more transportation data sources and one or more weather related data sources.

20. The computer program product of claim 18 wherein the actions performed by the information handling system further comprise:
retrieving one or more points of interest from the received points of interest, wherein the one or more points of interests have not yet been performed;
utilizing the QA system to analyze the user-defined factors in relation to each of the one or more points of interest;
re-identifying the constraints pertaining to each of the points of interest utilizing the travel-oriented data ingested into the QA system; and
generating an updated itinerary based upon the analysis and the identified constraints.
